(19) United States
(12) Patent Application Publication
(10) Pub. No.: US 2008/0302847 A1
(43) Pub. Date: Dec. 11, 2008

(54) Subsidiary vent channel of a nailing gun

(76) Inventor: Chung Ho Liu, Wufeng Shiang (TW)

Correspondence Address: KUO-HSIUNG CHIU, 13F., NO.23, JIUN-HO STREET, PEITUN DISTRICT, TAICHUNG, 406, TW

(21) Appl. No.: 11/810,142

(22) Filed: Jun. 5, 2007

(51) Int. Cl. B25C 7/00

(52) U.S. Cl. 227/16

(57) ABSTRACT

The invention related to a subsidiary vent channel of a nailing gun having a subsidiary vent hole at an internal plug of a rear cap. A subsidiary vent channel is disposed at a corresponding place of a rear cap. In this way, the compressed gas from the outside can be simultaneously injected into a nail-feeding air chamber of the gun body and the subsidiary vent channel. The gas injected into the nail-feeding air chamber serves for nailing. The gas injected into the subsidiary vent channel is available for different purposes.

### BACKGROUND OF THE INVENTION

1. Fields of the Invention

The present invention relates to a subsidiary vent channel of a nailing gun, and more particularly to a structure that makes a full use of the injected compressed gas for different purposes. Meanwhile, the original nailing effect won't be affected.

2. Description of the Related Art

It is a matter of common observation that the basic operation of the conventional pneumatic nailing gun employs the external compressed gas injecting into a nail-feeding air chamber of a gun body for performing the expected nailing process. As shown in FIGS. 5 and 6, the internal plug 11 of the rear cap 10 of the conventional nailing gun is designed in a closed construction such that the gas can be injected via an air inlet channel 12 and an air outlet 13 of the rear cap 10 directly into the nail-feeding air chamber 14 for performing the nailing process.

Moreover, U.S. Pat. No. 6,478,209 teaches a special nailing gun capable of simultaneous and automatic pad-feeding during the nailing operation. This nailing gun employs the compressed gas accumulated in the nail-feeding air chamber 14 to be injected in a divided-flow way into an automatic pad-feeding mechanism additionally fitted at the external side of the gun body such that the pads can be automatically pushed to the muzzle. In this way, a pad can be automatically fed in completing each of the nailing actions.

The above-mentioned construction has its own advantages. However, the gas amount within the nail-feeding air chamber 14 is fixed. When the amount of gas is divided, the nailing force will be reduced and insufficient. As a result, it happens frequently that the nails can't be fully brought into the work piece in position. This disadvantage considerably affects the effect of the innovation. Besides, the accumulation duration of the compressed gas will be prolonged since the gas has to be fully added to the nail-feeding air chamber 14 and the automatic pad-feeding mechanism. Accordingly, the nailing efficiency will be much affected, too. Thus, the conventional nailing gun requires further improvements.

### SUMMARY OF THE INVENTION

It is a primary object of the invention to provide a subsidiary vent channel of a nailing gun for simultaneously and separately feeding the compressed gas without prolonging the feeding duration of the nail-feeding air chamber and without affecting the original nailing efficiency and force. Meanwhile, the gas provided by the subsidiary vent channel is available to be power supply sources for the automatic pad-feeding mechanism, dust-removing guns, and other subsidiary mechanisms. As a result, a practical application can be obviously enhanced.

According to the invention, a subsidiary vent channel of a nailing gun includes a subsidiary vent hole at the internal plug of the rear cap. A subsidiary vent channel is disposed at a corresponding place of a rear cap. In this way, the compressed gas from the outside can be simultaneously injected into a nail-feeding air chamber and the subsidiary vent channel.

### BRIEF DESCRIPTION OF THE DRAWINGS

The accomplishment of this and other objects of the invention will become apparent from the following description and its accompanying drawings of which:

FIG. 1 is a partially exploded perspective view of the invention;

FIG. 2 is a perspective view of a preferred embodiment of a rear cap of the invention;

FIG. 3 is a perspective view of a preferred embodiment of the invention;

FIG. 4-1 is a perspective view of another preferred embodiment of the rear cap of the invention;

FIG. 4-2 is a perspective view of the rear cap according to FIG. 4-1 seen from another direction;

FIG. 5 is a partially exploded perspective view of the rear cap of a conventional nailing gun; and

FIG. 6 is a perspective view of the rear cap of the conventional nailing gun seen from another direction.

### DETAILED DESCRIPTION OF THE PREFERRED EMBODIMENT

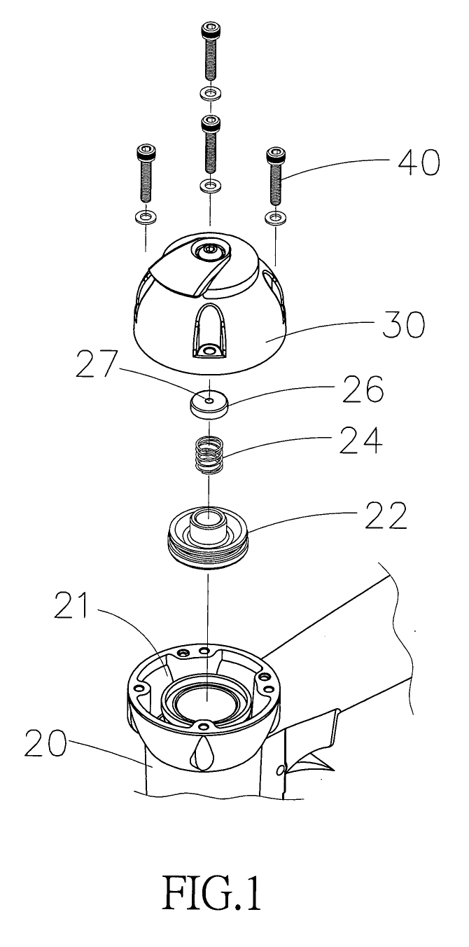

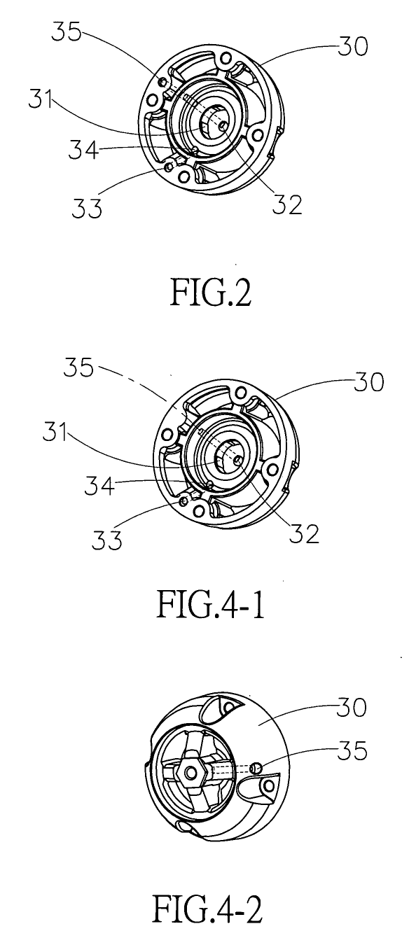

As shown in FIGS. 1 and 2, a nailing gun in accordance with the invention includes a gun body 20. A piston 22, an elastic element 24, an internal plug 26 and a rear cap 30 are joined together by a plurality of fixing elements 40 at the rear end of the gun body 20. A subsidiary vent hole 27 is formed in an end surface of the internal plug 26. The rear cap 30 includes a recess 31 for receiving the internal plug. A subsidiary vent channel 32 is disposed within the recess 31. In this way, the compressed gas from the outside can pass through an air admission channel 33 and then is simultaneously injected into a nail-feeding air chamber 21 of the gun body 20 and the subsidiary vent channel 32. The gas injected through a first air guiding hole 34 into the nail-feeding air chamber 21 serves for nailing. The gas injected into the subsidiary vent channel 32 is available for a prearranged second air guiding hole 35 for different purposes.

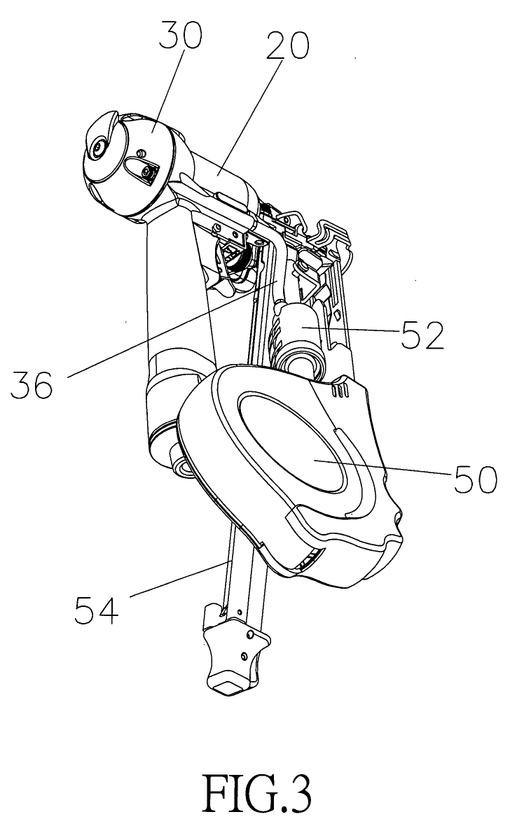

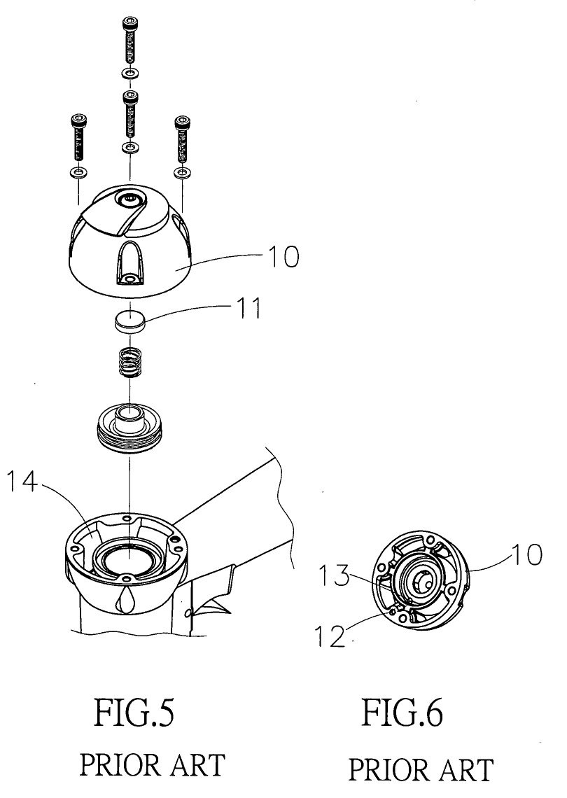

Referring to FIG. 3, the compressed gas is simultaneously injected into a pneumatic pusher 52 of an automatic pad-feeding mechanism 50 for performing the simultaneous automatic pad-feeding process.

Referring to FIG. 4, the second air guiding hole 35 can be disposed at the external side of the rear cap 30. In this way, the admission of the gas into the above-mentioned automatic pad-feeding mechanism 50 or a dust-removing gun (not shown) or another subsidiary mechanism requires only another air guide tube (not shown). Accordingly, a practical effect can be achieved.

The automatic pad-feeding mechanism 50, the pneumatic pusher 52, the nail-pushing magazine 54, and other relevant elements belong to the prior art objects. They are not the object of the invention so that no further descriptions thereto are given hereinafter.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claim.

1. A nail gun having a subsidiary vent channel a piston, an elastic element, an internal plug and a rear cap being joined together by a plurality of fixing elements at the rear end of a gun body, a subsidiary vent hole being formed in an end surface of the internal plug, the rear cap having a recess for receiving the internal plug, the subsidiary vent channel being disposed within the recess,
whereby the compressed gas from the outside can pass through an air admission channel and then is simultaneously injected into a nail-feeding air chamber of the gun body and the subsidiary vent channel,
wherein the subsidiary vent channel is configured to direct the compressed gas to a subsidiary mechanism.

2. The nail gun of claim 1, wherein the subsidiary mechanism is a pneumatic pusher of an automatic pad-feeding mechanism.

3. The nail gun of claim 1, wherein the subsidiary mechanism is a dust-removing gun.
